(19) United States
(12) Patent Application Publication
(10) Pub. No.: US 2018/0065399 A1
(43) Pub. Date: Mar. 8, 2018

(54) ONE-PIECE RIGID COVERS FOR DISC-BOUND FOLD-OVER BINDING SYSTEM AND USE OF COMPOSITE MATERIAL FOR MAKING THE SAME

(71) Applicant: Marnix Denys, Hoeilaart (BE)

(72) Inventor: Marnix Denys, Hoeilaart (BE)

(21) Appl. No.: 15/467,034

(22) Filed: Mar. 23, 2017

(30) Foreign Application Priority Data
Mar. 24, 2016 (BE) 2016/5209

(51) Int. Cl. B42F 13/00; B42F 3/00

(52) U.S. Cl. CPC B42F 13/0013; B42F 13/008; B42F 3/003

(57) ABSTRACT

The invention relates to a cover for disc-bound, fold-over binding systems, comprising a series of parallel T-shaped slits, characterized by the fact that the cover consist of a one-piece sandwich panel containing two rigid outer layers which are permanently attached to a flexible core layer, wherein the sandwich panel is provided with an area which runs parallel to the edge of the cover wherein between 0.1% and 100% of the outer layers of the sandwich panel is removed.

### CROSS-REFERENCE TO RELATED APPLICATION

This application claims priority to Belgian Patent Application No. 2016/5209, filed Mar. 24, 2016, the contents of which are herein incorporated by reference in their entirety.

### FIELD OF THE INVENTION

The invention concerns an improved, disc-bound, fold-over binding system and the covers and discs used herewith.

### BACKGROUND

Disc-bound, fold-over binding systems refer to systems wherein the covers and content can rotate for 360 degrees, and in which the covers and content can be removed and (re-) inserted. The most common use is in the stationary, diary and paperware products. Atoma™ binding systems contain a series of one-piece, round discs, two covers and loose sheets of paper. The paper sheets have cut-outs that allow that the sheets can be removed and re-inserted. The two covers have the same cut-outs and are connected with the round discs in the same manner, either by being one-piece and flexible, or by being composed by a flexible component and a rigid component.

These disc-bound, fold-over binding systems exist since 1948. The advantages of disc-bound, fold-over binding systems are well known. By the combination of the advantages of ring-binders and spiral notebooks they provide the flexibility of a ring-binder with the portability of a notebook. Disc-bound, fold-over notebooks provide the users the possibility of replacing, (re-)ordering and/or adding pages. This happens without affecting the integrity of the paper. Finally, because of the possibility to rotate the covers and the content 360 degrees, these notebooks are ergonomic when writing at a desk or while keeping the notebook in one hand. The largest disadvantage is that the covers have either to be flexible enough to be bound with the current one-piece discs, or have to contain a flexible piece that allows this. As a result, the current flexible one-piece covers have a limited lifetime and user-friendliness and provide only a limited protection to the content. The current multiple-piece covers present a limitation in choice and additional steps in manufacturing.

This disc-bound fold-over binding system has been largely unchanged since its development in 1948.

### SUMMARY OF THE INVENTION

This invention aims towards an improvement of the current disc-bound, fold-over binding systems. The conventional covers for disc-bound, fold-over binding systems, in accordance with the prior art, are either one-piece (as shown in FIG. 1B) and made out of flexible materials such as polypropylene, cardboard or leather, or multiple-piece (as shown in FIG. 1C) and made out of a combination of flexible and rigid materials. In the multi-piece covers, the flexible material is located at the edge of the cover, where the discs are inserted, and the rigid material, typically reinforced leather, is used for the remainder of the cover.

The one-piece disc (1) used in disc-bound fold-over binding systems (as shown in FIGS. 1C and 1D) is made out of solid material, typically injection-moulded plastic, sometimes aluminium or wood. A conventional cover can only be bound with the one-piece discs if the cover is made out of relatively flexible material, of if the cover contains flexible material at the location where the cover needs to be bound with the discs

The covers (2) of disc-bound, fold-over binding systems have a series of T-shaped slits at one edge, so that the slits fit over the discs. The current one-piece covers (1B) are made out of a flexible material such as cardboard, plastic (usually polypropylene) or leather. The thickness of flexible one-piece covers varies: Cardboard covers are typically 0.5-0.6 mm thick, polypropylene covers typically are 0.6 mm-0.7 mm thick, leather covers typically are 1.5 mm-3.0 mm thick. The conventional multi-piece covers have a flexible component (usually polypropylene) with a width of 15-20 mm, and a height that is equal to the height of the cover. The thickness of a conventional multi-piece cover varies: the flexible part of the cover will typically be 0.5 mm-0.7 mm thick, where the rigid part of the cover will typically be 1.5 mm-5 mm thick. The rigid part of the cover is usually made out of (faux-)leather, which is stitched or glued on to the flexible part.

One-piece flexible covers do not provide the support to the action of writing when no desk is available, therefore reducing the comfort and negatively impacting the end result. Moreover, these flexible and little lasting covers provide insufficient protection of the paper content during transportation of the notebook. By their limited lifetime, these non-durable covers have a negative environmental impact. When the conventional note-book is discarded, the plastic discs and covers have a negative environmental impact. The more durable multi-piece covers take up more space, represent a limitation to the choice of materials and have repercussions on manufacturing costs, as assembly steps are needed to combine the flexible part of the cover with the rigid part of the cover.

The invention concerns a one-piece cover (2), which can be attached to the one-piece discs (1) of disc-bound fold-over binding systems, comprising a rigid sandwich panel consisting of two rigid outer layers and a flexible core layer. In certain embodiments, the sandwich panels contain aluminium outer layers and a polypropylene core layer. The one-piece cover referred to herein is made out of a sandwich composite panel containing a series of T-shaped slits, and is further characterized by a selective removal of the outer layers in order to create flexible flaps. These make it possible to assemble the rigid and one-piece composite panel with the discs.

The present invention thus relates to a cover (2) for disc-bound, fold-over binding systems, and more particularly a one-piece cover (2) with a series of parallel T-shaped slits (7), wherein the long leg (10) of any of the T (7) is placed at an angle of 90° with a straight edge (8) of the panel, and extends to the edge (8) of the panel, characterized by the fact that the cover consists of a one-piece sandwich panel having two rigid outer layers (12A, 12B) which are permanently attached to a flexible core layer (13), and wherein the flexible core layer is exposed in the section of the cover comprising the T-shaped slits (7). In particular embodiments, the sandwich panel is provided with one or more flexible surfaces in an area extending from the edge of the cover whereby in this area, between 0.1% and 100% of the outer layers (12A and 12B) of the sandwich panel is removed. The border of this area is illustrated herein in the figures with virtual line 17. In particular embodiments this is an area extending from the T-shaped slits up to the straight edge (8) of the cover. In certain further embodiments, the flexible core-layer is exposed over the entire surface located under the arms of the T's. In certain further embodiments, the flexible core-layer is exposed in the surfaces located under the arms of the T's (7). In certain embodiments, the flexible core-layer is exposed in grooves that run from the tip of each arm of each T (7) to the edge (8), according to an angle α in relation to this edge (8), wherein this angle α is between 30° and 91°. In certain further embodiments the section of the cover wherein the flexible core layer is exposed completely encompasses the T-shaped slits (7).

The invention also relates to a set of two or more covers such as described herein and on a binding system that includes such a set of covers, and one or more matching discs. In certain embodiments, the binding system further comprises one or more elements such as paper, cardboard or soft plastic, with the same T-shaped slits. In certain embodiments of the binding system the set of discs is made from aluminium.

### BRIEF DESCRIPTION OF THE FIGURES

The following description of the figures of specific embodiments is only for illustration purposes and is not meant to limit the current disquisition, its application or its use. In the drawings the corresponding reference numbers refer to ditto or corresponding parts and characteristics.

FIG. 1A-1C: shows a disc-bound fold-over binding system. FIG. 1A shows the cover of the system, together with a set of discs. FIG. 1B shows the current prior art, with the elements of disc-bound, fold-over binding systems, namely discs (1) and a one-piece, flexible cover (3). FIG. 1C shows another embodiment of the current prior art of the elements of disc-bound, fold-over binding systems, namely discs (1) and multi-piece covers, where the flexible part (4A) of the cover can be bound to the discs, and where the rigid part (4B) provides rigidity to the remainder of the cover.

FIG. 2A-2C: FIG. 2A shows a solid disc, with a flat core and a rim, FIG. 2B shows a more translucent view on a solid disc, to appreciate the flat core (6). FIG. 2C shows a cross-section of the disc, with the raised rim (5) and the flat core (6), including the approximate measures in mm of a disc with a diameter of 20 mm.

FIG. 3A-3D: FIG. 3A shows a top-view in close-up of two discs (1), the edge (8) of the cover where the T-shaped slits (7) are located, and the flexible cover (3) or the flexible part (4A) of a multi-piece cover, before the assembly of discs and cover according to an embodiment of the invention. The reader will understand that the flaps (9A, 9B) need to be flexible and elastic enough to be able to temporarily fold open so that the flexible cover (3) or the flexible part of the cover (4A) is able to connect with the discs (1). FIG. 3B shows a top view in close-up after assembly. FIG. 3C shows a portion of the cover in close-up and the cross-section of a disc after assembly. The space between the flaps (9A, 9B) is wider than the thickness of the flat core (6) of the disk. It will be understood that the flaps (9A, 9B) hook behind the raised rim (5) of the disc (1), and yet have the freedom to rotate. FIG. 3D shows the approximate dimensions in mm of a T-shaped slit (7). Also, the arms (11A, 11B) and the long leg (10) of the T (7) are indicated.

FIG. 4A-4C: FIG. 4A shows a cross-section view of a sandwich laminated panel, with two rigid outer layers (12A, 12B) bonded to a flexible core layer (13), and by way of example, the dimensions in mm of the thinnest Hylite®. FIG. 4B shows a cross-section view of a laminated sandwich panel with grooves (14A, 14B), where a narrow strip of the rigid outer layer material (12A, 12B) is removed on both surfaces opposite to each other to create a hinge-groove (15). FIG. 4C shows a cross-section view of a hinged laminated sandwich panel with hinge-grooves.

FIG. 5A-5B: FIG. 5A shows the front (16A) and the back (16B) of a sandwich panel, with a series of parallel T-shaped slits (7), wherein the long leg of each T is set at an angle of 90° with an edge of the cover, and extends to this edge of the cover, and with an indication of an example of the edge (8) in which the T-shaped slits (7) are located, and of the virtual line (17) which, in this embodiment runs along the underside of the arms of the T's, from one side of the panel to the other side of the panel. Note that the front (16A) and back (16B) are each other's mirror image. The area between the edge (8) and the line (17) is the area in which, in this embodiment, the flexible surfaces or zones of elastic hinges are located (though not visible in this figure). FIG. 5B shows a close-up, with detailed indication of the long leg (10) of the T (7), and of the arms (11A, 11B) of the T (7). Also, the line (17) delimiting the area in which the flexible core is uncovered which runs underneath the arms (11A, 11B) of the T's (7), is indicated (though not uncovered in this illustration), as well as the edge (8) where the T-shaped slits (7) are located.

FIG. 6A-6C: FIG. 6A shows the front (16A), —and the back (16B) of one embodiment of a cover consisting of a sandwich panel, where the outer layers (12A, 12B) have been completely removed in 100% of an area between the edge (8) and line (17), and one only can see the exposed core layer (13) in that area. Note that 16A and 16B are each other's mirror image. FIG. 6B shows a close-up of a portion of this embodiment. Since the flaps (9A, 9B) are positioned in this area and now only consist of the flexible core layer, they are elastic enough to be connected to the discs. FIG. 6C shows a side view.

FIG. 7A-7B: FIG. 7A shows the front (16A), —and the back (16B) of a second embodiment of a cover consisting of a sandwich panel, where the outer layers (12A, 12B) have been completely removed in all of the areas which are under the arms of the T's (7). So, between the edge (8) and the underside of all the arms of the T's (7) only the exposed core layer (13) remains. Note that 16A and 16B are each other's mirror image. FIG. 7B shows a close-up of a portion of this embodiment. Here, too, the flaps (9A, 9B) are flexible enough to be connected to the discs.

FIG. 8A-8B: FIG. 8A shows the front (16A), —and the back (16B) of a third embodiment of a cover consisting of a sandwich panel, with a groove (14A, 14B) for each arm of the T's (7), on both sides of the panel. These grooves run from each tip of each arm of each T to the edge (8), where the slits are located, and are at an angle to this edge (8). FIG. 9B shows a close-up of a portion of this embodiment. These elastically hinging flaps (18A, 18B) can elastically hinge open and close to be connected to the discs.

FIG. 9A-9B: 9A shows the front (16A), —and the back (16B) of a fourth embodiment of a cover consisting of a sandwich panel, with a groove (14A, 14B) for each arm of the T's (7), on both sides of the panel. These grooves run from each tip of each arm of each T to the edge (8), where the slits are located, and are perpendicular to this edge. FIG. 9B shows a close-up of a portion of this embodiment. These elastically hinging flaps (18A, 18B) can elastically hinge open and close to be connected to the discs.

FIG. 10A-10B: FIG. 10A shows the front (16A), —and the back (16B) of a further embodiment of a cover according to the invention, where the outer layers (12A, 12B) have been completely removed in all of the areas which are under the arms of the T's (7). Indeed in this embodiment, the section of the exposed flexible core layer of the sandwich panel (13) extends from the edge (8) of the panel to a line (17) which runs just above the T-shaped slits (7) so that, not only the region located along the underside of the arms of the T's is exposed but the T's (7) are completely surrounded by the are exposing the flexible core layer. FIG. 10B shows a close-up of this embodiment.

The following references were used in the description and figures: 1: disc; 2: Cover; 3: Conventional flexible one-piece cover; 4A: Flexible part of a conventional multi-piece cover; 4B: Rigid part of a conventional multi-piece cover; 5: raised rim of disc; 6: flat core of disc; 7: T-shaped slit; 8: Edge of the cover where the T-shaped slits are located; 9A, 9B: Flap; 10: Long leg of the T; 11A, 11B: Arms of the T; 12A, 12B: Outer layers of sandwich panel; 13: Flexible core layer of sandwich panel; 14A, 14B: Elastic hinging grooves; 15: Elastic hinge in sandwich panel; 16A, 16B: Front and back of cover made of sandwich panel; 17: Virtual line designating the area in which the flexible core layer is exposed to ensure elastically hinging flaps; 18A, 18B: Elastic hinge-flaps, consisting of elastic hinging grooves and a component with all 3 layers of the sandwich panel.

### DETAILED DESCRIPTION

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited components, elements or method steps also include embodiments which “consist of” said recited components, elements or method steps.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints.

All documents cited in the present specification are hereby incorporated by reference in their entirety.

Unless otherwise defined, all terms used in disclosing the invention, including technical terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

As determined herewith an object is “oblong” when the length of the object is longer than 4 times the width of that object. By preference the length is longer than six- or eight times the width of the object.

As determined herewith an object is “thin” when the width of the object is larger than twice the thickness of that object. By preference the width is larger than four- or six times the width of that object.

The term “extremity” of a lath as used herewith is also composed of the elements of the lath that are close to that extremity; more specifically the elements that are at a distance of the extremity which is smaller than 10% of the length of the lath, by preference less than 5% of the length of the lath.

The term “perpendicular” as used herewith can comprise a certain deviation of an exact perpendicular orientation. More specifically, a first (even) object is considered perpendicular relative to a second (even) object when the angle between the planes of these objects is between 85° and 95°, by preference between 87° and 92°, even better between 88° and 91°, and ideally 90°.

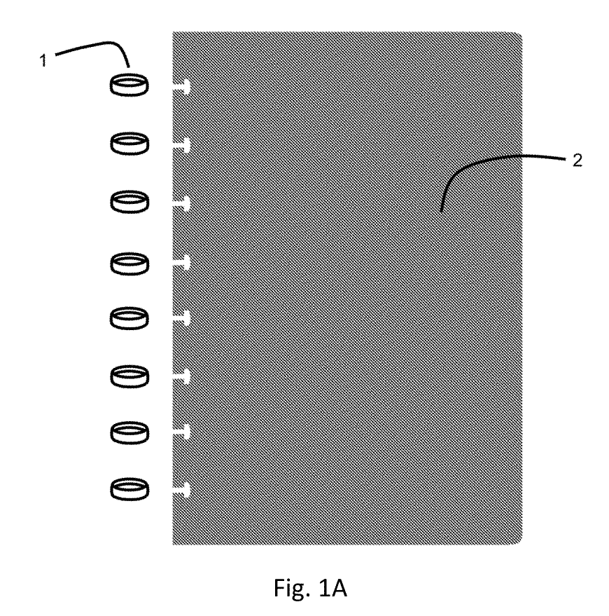

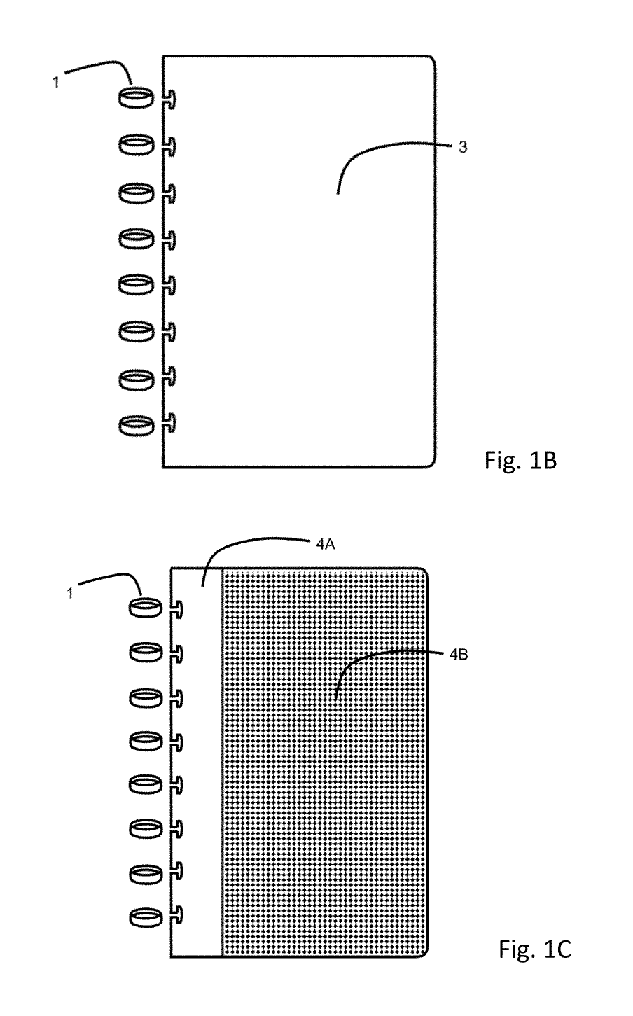

The term “parallel” as used herewith can comprise a certain deviation of an exact parallel orientation. More specifically, a first (even) object is considered parallel relative to a second (even) object when the angle between the planes of these objects is between 0° and 5°, by preference between 0° and 2°, even better between 0° and 1°, and ideally 0°. The present invention relates to binding systems in the paper industry. More specifically the present application relates to a cover for use in disc-bound fold-over binding systems, as for instance used in the paper-ware industry. These systems are illustrated in FIG. 1. Disc-bound, fold-over binding systems refer to systems wherein the covers and content can rotate 360 degrees and where the covers and content can be extracted and inserted. The most used application is in the field of notebooks, diaries and stationary products.

The invention relates to covers made of a one-piece sandwich panel for use in disc-bound fold-over binding systems. The covers are characterized by the materials that are used in the one-piece sandwich panel, and the manner in which they are adapted for this specific use.

The term “composite sandwich panel” or “one-piece sandwich panel” as used herein refers to a laminate panel which is constructed by permanently connecting three layers of at least two different materials with each other. In the preferred embodiment, a composite sandwich panel comprises two stiff outer layers from the same material, permanently connected to a flexible core layer in the middle. The term “composite” or “one-piece” refers to the fact that the different materials are connected with one another in such a way that it is impossible to separate the layers of a sandwich panel from one another manually or with simple hand tools. By the use of a combination of stiff outer layers and a flexible core, a cover is obtained which is substantially rigid but yet locally sufficiently flexible to allow the assembly with rigid discs. The sandwich panel may consist of different materials, as long as the outer layers (12A, 12B) are different from and preferably are more rigid than the flexible core layer (13). Thus, the rigid outer layers, for example, may be of aluminium or steel, and the core-layer of polypropylene, as described in U.S. Pat. No. 5,814,395. In more specific embodiments, the cover consists of a metal-polypropylene-metal laminate, wherein the three layers are permanently bonded together with a binder containing a thermosetting component and a polypropylene thermoplastic component. In certain embodiments, the panel is 1.2 mm thick, consisting of two aluminium plates of each 0.2 mm thick bonded to a core plate of polypropylene of 0.8 mm. In other embodiments, the panel is 2.0 mm thick, wherein the polypropylene plate is 1.6 mm thick. In a particular embodiment, the cover may be made of Hylite®, made by 3AComposites, with the outer layers consisting of aluminium and the core-layer of polypropylene. In other embodiments, the core-layer may consist of other suitable flexible material, such as a thermoplastic material, a foam or silicone.

A particular feature of the composite layers envisaged herein is that, if one mills away the outer layer, along both sides of the composite panel, and in exactly the same place, a flexible, elastic zone is created with an exposed elastic inner layer forming an elastic hinge. The term “elastic hinge” refers to the fact that the hinging element can bend under force but returns back to the flat/straight position when the bending force falls away, and that one can repeat this bending countless times. If one makes a similar groove on only one side of the panel, the panel will remain in the bent position when the bending force is removed.

A cover for use in disc-bound fold-over binding systems as envisaged herein is generally provided with a series of parallel T-shaped slits (7), as with conventional covers, wherein the long leg (10) of each T (7) is disposed at an angle of 90° with an edge (8) of the cover, and extends to this edge (8) of the cover. The “flaps” of the cover are the zones (9A, 9B) which extend from underneath the arms (11A, 11B) of the T and the edge (8) of the cover.

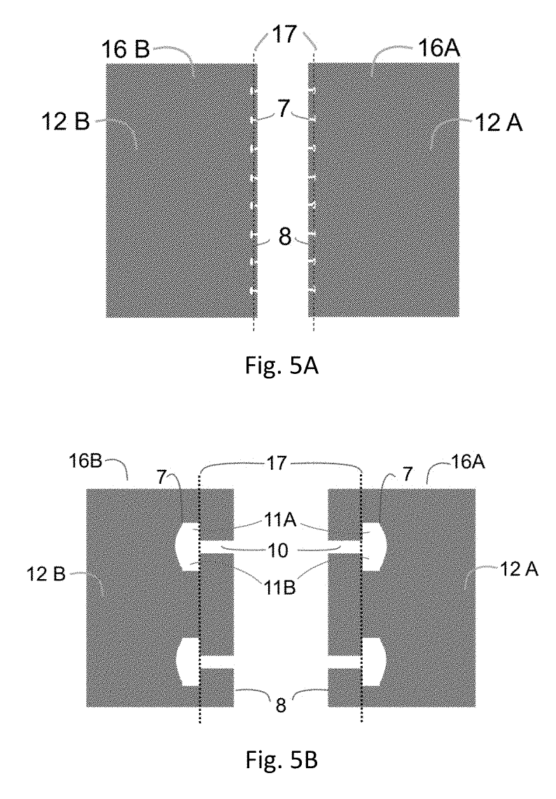

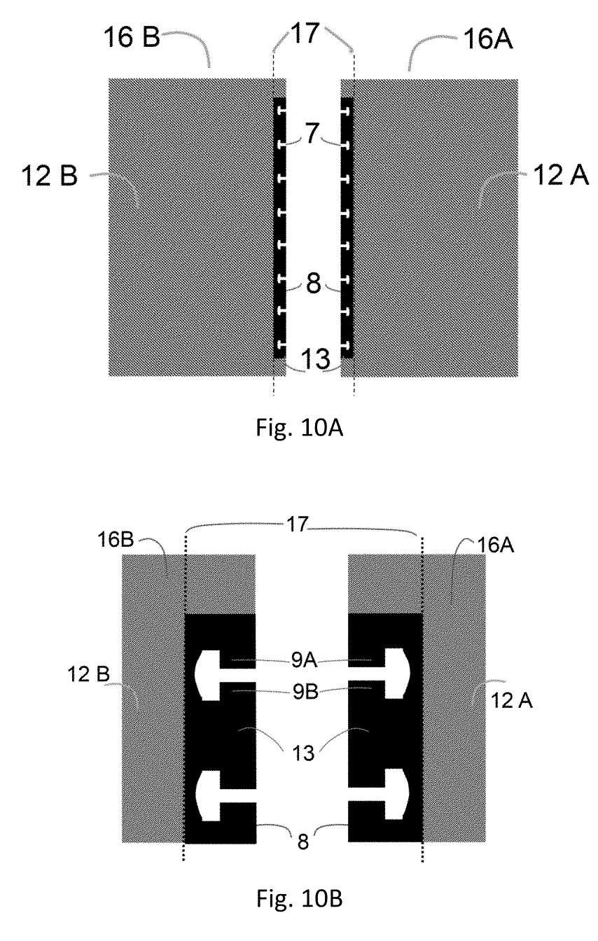

By removing the outer layer of the composite sandwich panel at specific locations adjacent to the slits, the flaps become bendable, which facilitates the use with the one-piece discs. According to the present invention, in an area of the cover, the flexible core is partially or wholly exposed on both sides of the sandwich panel to ensure the flexible binding flaps. This area is formed by a strip which runs parallel to the long edge of the cover over the T-shaped slits (8) and is delineated in the figures herein with a virtual line (17). The width of this area, in which the flexible core is partially or wholly exposed to improve the flexibility of the flaps typically does not extend from the edge further than 1 cm, preferably not further than 0.5 cm from the virtual line connecting the top of the T-shaped slits. Accordingly, this area typically is less than 3 cm, typically less than 2 cm wide (depending on the length of the T-shaped slots). In particular embodiments, this area is a strip which extends from the long edge connecting the arms of the T-shaped slits (e.g. FIG. 5). In these embodiments, the width of this area is therefore as wide as the length of the long leg (10) of the T's (7), and is typically between 2 mm and 7 mm, more particularly between 4 mm and 6 mm. In certain embodiments this area is wider, so that the T's are totally surrounded by the exposed flexible core layer (FIG. 10). In particular embodiments, this area is about 0.8 cm0.9 to 1.5 cm, such as 1.1 cm wide extending from the edge (8) of the cover. The height of this area of flexible surface or exposed flexible core can be as high as the cover (i.e. extending from one short side of the cover to the next), or can be shorter, but preferably extends between the one outer T-shaped slit to the other. The height of the cover itself depends on the desired height of the notebook. Standard heights which may be provided herein include, for example but not limited to 148 mm (A6), 210 mm (A5), 297 mm (A4), etc. . . . Outside this area, the cover mainly consists of the intact sandwich panel (though further limited areas with an exposed flexible core may be provided, unconnected to the T-shaped slots, as detailed below).

According to the present invention, the outer layers are removed in this area, on both sides of the panel, either completely or in accordance with certain patterns, so that the front and the back of the cover are each other's mirror image. More specifically, in this area between 0.1 and 100% of the outer layers are removed to create one or more flexible surfaces.

A flexible surface, refers to a surface of the cover which only contains the flexible core layer of the sandwich panel and is characterized by the fact that the outer layers are removed or are not present.

In certain embodiments of the invention, the rigid material of the outer layers of the sandwich panel is completely removed over the whole area which is located between the edge (8), where the T's (7) are located and a straight line (17), which runs parallel to the arms of the T's and the area encompasses the T's. This embodiment is illustrated in FIG. 10.

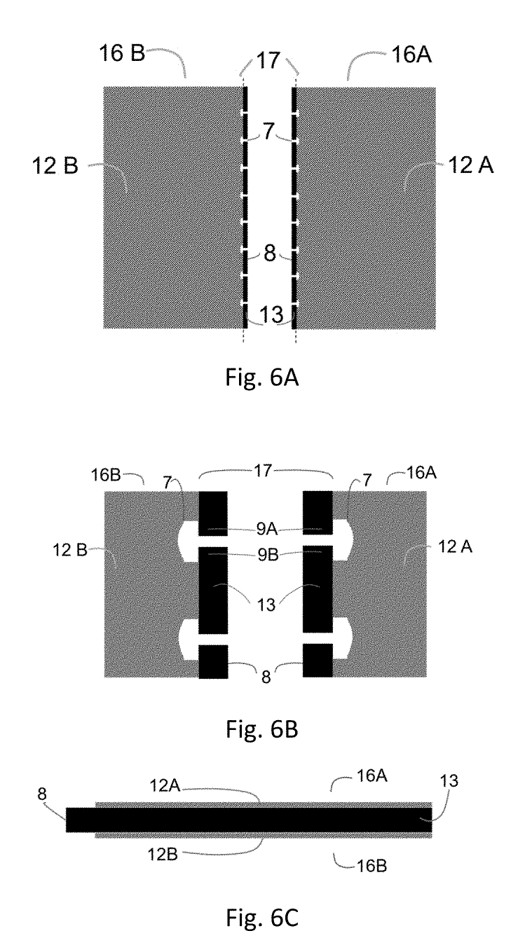

In certain embodiments of the invention, the rigid material of the outer layers of the sandwich panel is completely removed over the whole area which is located between the edge (8), where the T's (7) are located and a straight line (17) running through the underside of all arms (11A, 11B) of all T's (7), from the upper edge of the cover to the lower edge. This embodiment is illustrated in FIG. 6.

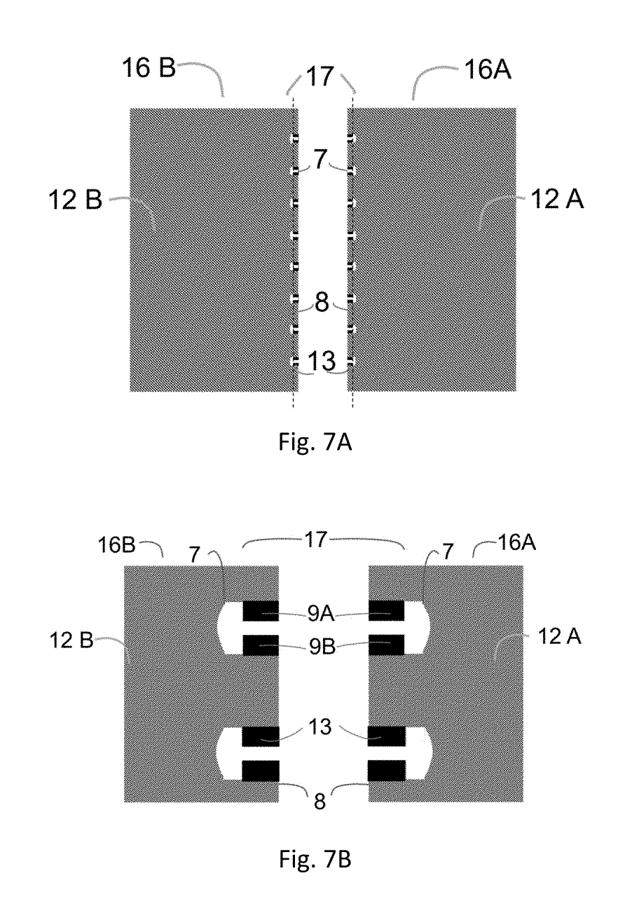

In certain embodiments, the flexible core layer is only exposed in the areas directly underneath the arms of the T's. More particularly, the flexible core layer is exposed only on the surface of the flaps (11A, 11B) below the T-shaped slits. This allows the flaps to be flexible. This embodiment is illustrated in FIG. 7.

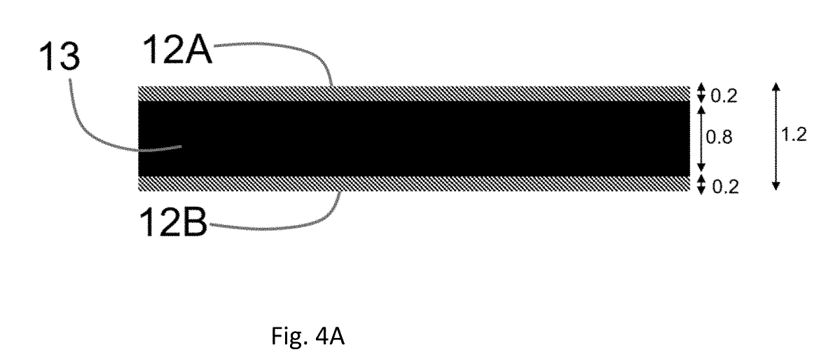

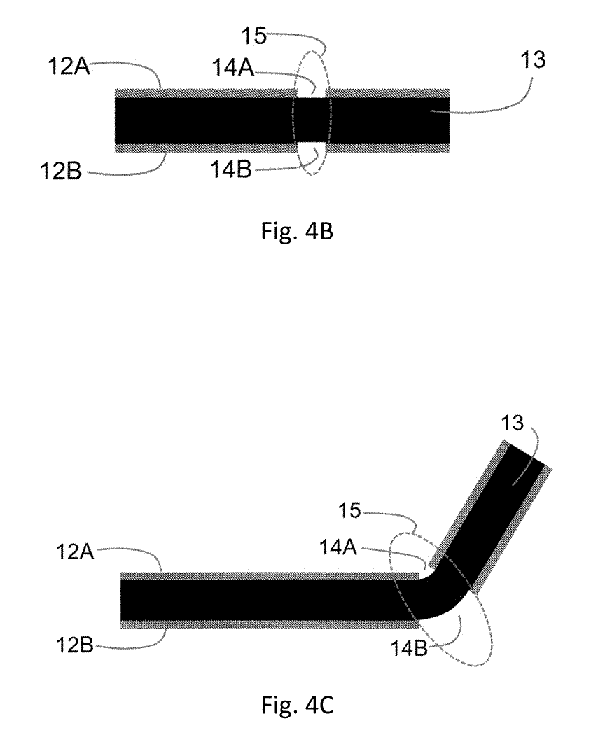

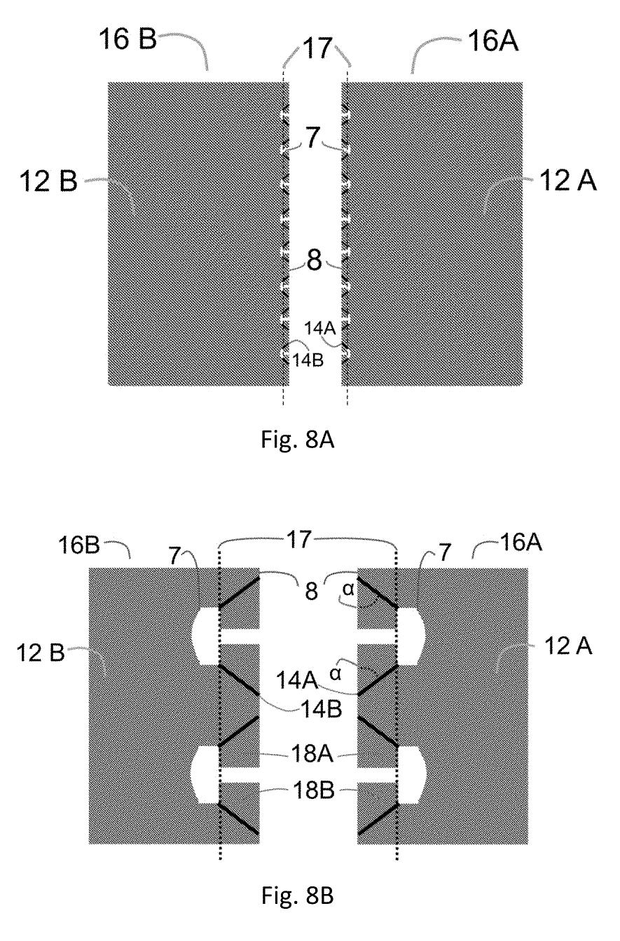

In certain embodiments, the core layer is exposed in accordance with a restricted pattern in the area between the edge (8) where the T's (7) are located and a straight line (17) running through the underside of all the arms (11A, 11B) of all T's (7). Thus, the invention provides, in certain embodiments, elastically hinging grooves. A groove in this area on both sides of the panel, wherein the flexible core layer of the sandwich panel is exposed, can take on the function of a hinge and make the bending of the flap possible. In this embodiment, use is made of the possibility to make elastically hinging grooves in a sandwich panel with an elastic core layer. The characteristic of an elastically hinging groove is that the outer layer of the sandwich panel is removed, from an edge of the T-shaped slit to the opposite edge of the cover. The grooves have a width of 0.5-2 mm. An elastically hinging groove is illustrated in FIG. 4B and FIG. 4C. In this embodiment of the invention described herein, a straight elastic hinging groove (14A, 14B) runs from the end of each arm (11A, 11B) of each T (7), up to the edge (8), where the T's (7) are located, at an angle (a) with this edge (8). The angle α is between 30° and 91°, such as, for example, about 30°, about 35°, about 40°, about 45° or about 50°, or between 40°-50°. The result of these elastically hinging grooves is that a hinging flap (18A, 18B) is obtained, consisting of the groove with the exposed elastic material of the core layer, and the rest of the flap, where the three layers of the sandwich panel are intact. Since the grooves are located on both sides of the cover, the front and the back of the cover are each other's mirror image. This embodiment is illustrated in FIG. 8.

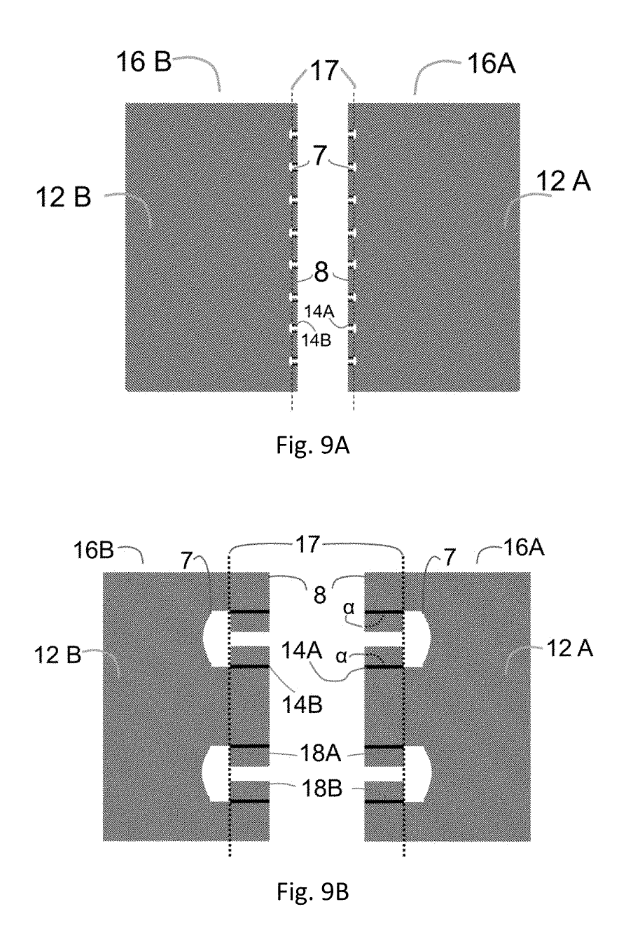

In a further embodiment, use is also made of the elastically hinging grooves. In this embodiment of the invention described herein, a straight elastic hinging groove (14A, 14B) runs from the end of each arm (11A, 11B) of each T (7), up to the edge (8), where the T's (7) are located, and is perpendicular to this edge (8). In other words, the angle α is 90°. The result of these elastically hinging grooves is that a hinging flap (18A, 18B) is obtained, consisting of the groove with the exposed elastic material of the core layer, and the flap itself, where the three layers of the sandwich panel are intact. Since the grooves are located on both sides of the cover, the front and the back of the cover are each other's mirror image. This embodiment is illustrated in FIG. 9.

In a further embodiment, the flexible core layer is exposed over the entirety of the area extending from edge (8) of the cover, in a way that the T's (7) are totally surrounded by the exposed flexible core layer (13). This allows efficiency in manufacturing because the T-shaped slits (7) can easily be punched once the rigid outer layers of the sandwich panel are removed. An example of this embodiment is shown in FIG. 10.

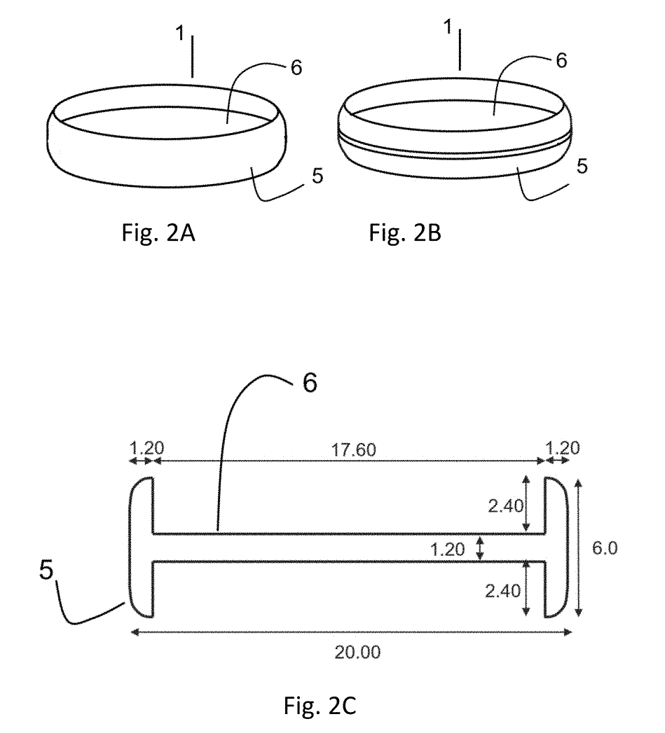

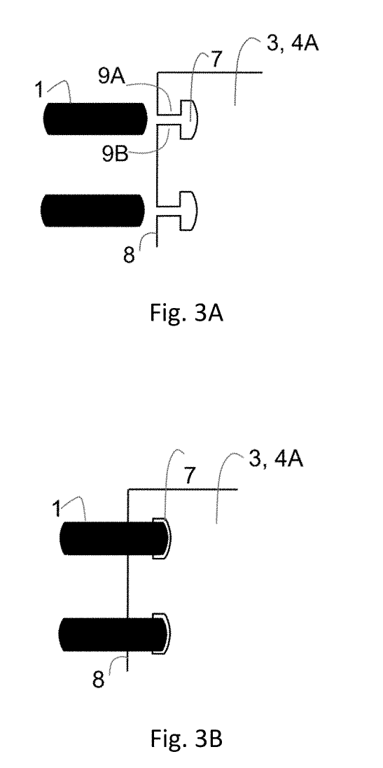

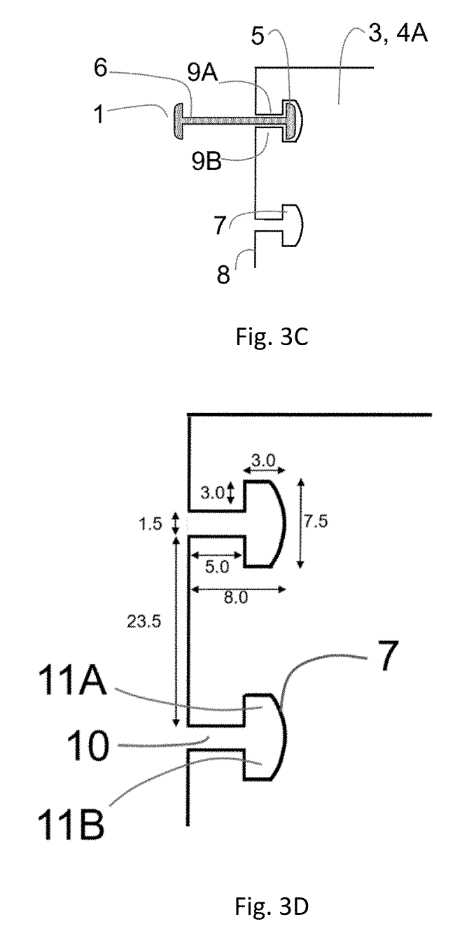

The shape of the covers is not critical to the invention, but it is typically rectangular. In particular embodiments the covers are slightly larger than the content that is fitted for the binding system, for example in a notebook, covers can be slightly larger than the paper content. The dimensions of the covers according to the described invention will vary, and will depend on the dimensions of the desired notebook. Standard measurements that can be provided are for example but not exclusively 9×14 cm, 11×17 cm, 14.8×21 cm (A5), 16.5×21, 21×29.7 (A4), etc. . . . In a preferred embodiment of the disclosed invention, the rigid and durable covers have a series of parallel T-shaped slits (7), wherein the long leg (10) of each T (7) is disposed at an angle of 90° with an edge (8) of the cover, and extends to this edge (8) of the cover. In these covers the shapes of the T-shaped slits are equal to, and preferably slightly larger than the dimensions of the disc which is used hereby, so that the covers can easily rotate 360 degrees along the rim of the discs. More specifically, this means that the T-shaped slit corresponds to the cross section of half a disc, and that the slit is slightly larger than this cross-section in order to allow the free rotation (see FIG. 2, FIG. 3). The thickness of the covers according to the described invention also varies, and depends on the range of possible sandwich panels, and of the ultimate thickness of the desired specification. In a preferred embodiment, the thickness of the cover is 1.2 mm.

As described herein, the covers according to the present invention are characterized by the fact that the outer layers of the composite sandwich panels have been removed in a particular area connecting to the T-shaped slots. Outside this area connecting to the T-shaped slits, the outer layers are present on the cover, or at least over the greater part of the surface of the remainder of the cover. This is important in order to ensure the rigidity of the cover. However, it is possible that in certain embodiments, for example for aesthetic purposes, the outer layer on one side of said cover is also removed in accordance with certain patterns outside the area described herein. These patterns are then usually characterized by the fact that they are provided only on one side of the cover (such that the flexible inner core is only exposed on one side. In further particular embodiments, these areas do not extend to an edge of the cover (whether or not formed by the T-shaped slits) and/or do not extend to the T-shaped slits. However, in particular embodiments, such patterns are provided over the entire surface of one side of the cover and extend towards the area comprising the T-shaped slits. However, ideally the patterns do not expose more than 60%, preferably not more than 50%, most preferably not more than 40%, 30 or even 20% of the cover and are remote from the area of the cover comprising the T-shaped slits, so that the patterns (e.g., letters, logo's) do not compromise the rigidity of the cover.

The present invention also provides sets of the covers described herein, more particularly combinations of 2 or more covers, preferably 2, or a multiple of two covers. The covers according to the present invention are used in combination with one-piece discs. The discs typically consist of a flat core (6) and a rim (5) that runs over the entire circumference of the flat core. The general characteristics of the circular flat core, the rim and disc are described below. The diameter of the disc may vary depending on the thickness of the target binding system such as, for example, a notebook. Typically, the outer diameter of the disc is between 15 mm and 50 mm. The flat core is quite thin, in order to allow the paper to remain bound. Thus, the thickness of the flat core is typically between 0.2 and 3 mm, in particular between 0.5 and 1.5 mm. The disc surface is typically smooth and continuous. The width of the rim is typically between 2 mm and 10 mm, in particular between 2 mm and 6 mm. For example, in disc drives of Atoma™ and ADOC systems, the width of the rim is about 3 mm. The rim of the disc sticks out on both sides of the flat core. That is also the reason why the slits in the covers are T-shaped. When one speaks of covers and matching discs, this refers to the fact that the discs, with regards to dimensions, fit into the T-shaped slits in the covers.

The present invention also provides binding systems which comprise one or more covers according to the present invention and a series of discs. In the combinations as provided here, the number of discs is equal to the number of T-shaped slits in the cover. The material of the discs is not critical to the invention. Nevertheless, the covers as described herein are particularly useful in combination with discs made of aluminum. Typical ways of finishing of covers and discs are, but not limited to, anodizing, powder coating, chroming, UV-printing etc.

In certain embodiments, these combinations also include additional elements such as, for example, (whether or not blank, lined, or squared) paper, cardboard separator sheets, plastic covers, etc . . . , whereby these are provided preferably at one edge with a series of parallel T-shaped slits corresponding in shape with the (semi) cross section of the discs of the combination.

In certain embodiments, at least one of the two covers is also provided with structures which can ensure additional functions of the cover. Examples of such structures are holders for writing materials, for electronic devices such as a tablet, calculator etc., folders for paper, and the like.

In certain embodiments, at least one of the two covers is also provided with holes or slits through which an elastic band or other closure material can be connected, to ensure the closure of the binding system.

The present invention also provides methods for making the covers according to the present invention. More specifically, these methods comprise the steps of (a) removing the outer layers of the composite sandwich panel in an area which runs parallel to the edge of the cover. In particular, the area provided is an area which extends from the edge of the cover such that it can encompass at least the region below the arms of the T-shaped slots to be provided therein and (b) providing the composite sandwich panel with the T-shaped slits in said area. In alternative embodiments, the methods comprise (a) providing a composite sandwich panel with T-shaped slots and (b) removing the outer layers of the composite sandwich panel in an area which runs parallel to the edge of the cover, which area comprises the T-shaped slots. Particular embodiments of how the outer layers are removed to ensure that the flaps under the T's are flexible are described herein above. In certain embodiments, the method includes the making of covers cut from a composite sandwich panel, the provision with the T-shaped slits and the removal of the outer layer in the area as described above. With these methods the outer layers are removed according to the patterns described above, meaning where flexible surfaces and/or hinged grooves are generated. The methods for the removal of the outer layers are dependent on the nature of the material of the outer layers, but are methods known to the skilled person.

In certain embodiments, the outer layers consist of aluminium, and this can be removed by milling. In such embodiments, T-shaped slits are made by punching or milling.

A notebook covers to which this invention refers, will protect the content of the notebook many times better than the conventional covers, or even multi-piece covers. This is because the stiffness of the sandwich panels is very high. In certain embodiments, the outer layer of the sandwich panel is made of aluminum. The modulus of elasticity (“Young's Modulus”) of aluminium composite panels, such as Hylite® is similar to that of glass, around 70,000 NMA. For comparison, the modulus of elasticity of polypropylene, commonly used for conventional, one-piece flexible covers, amounts to 11,000 NMA. Another important utility and advantage of this invention is that more choice arises concerning the choice of the durable materials of the covers, and also concerning the finishing of this material. For example, durable covers made out of a one-piece aluminium composite panel are now possible, and these can be powder coated, anodised, chromed, printed, embossed, etc. . . . Moreover, in certain embodiments, it gives the possibility to the user to compile the notebook and to assemble it by him/her-self.

Another advantage is the avoidance of additional steps in the production process. Since the sandwich panels are one-piece, only milling, or punching and milling, is sufficient for the production of a one-piece rigid cover, in contrast to the current state of the art in multi-part cover sheet, where the flexible portion and the rigid portion of the cover assembled with each other needs to be in order to achieve a cover with rigid properties.

There are also aesthetic benefits, as in certain embodiments presented here, the one-piece rigid covers have a uniform appearance, whereas the conventional, multi-piece rigid covers combine a minimum of two different kinds of materials. The last advantage relative to the conventional multi-part covers is that this invention can reduce the thickness of the cover to 1.2 mm, where the rigid multi-piece cover, by the combination of the materials, needs a thickness of 4 mm or more. A notebook with a thinner cover has the advantage that it can either contain more content, or require less space.

The present invention will be described with respect to particular embodiments but the invention is not limited thereto but only by the claims. Any reference signs in the claims shall not be construed as limiting the scope thereof.

### Examples

FIG. 4A-4C shows the composition of a sandwich panel according to an embodiment of the invention. FIG. 4A shows a sectional view of a sandwich panel, with two rigid outer layers (12A, 12B), attached to a flexible core layer (13), and, by way of example, the dimensions in mm of the thinnest Hylite®. FIG. 4B is a sectional view of a sandwich panel, in which in two elastically hinging grooves (14A and 14B), the rigid outer layers (12A, 12B) have been removed, in order to achieve an elastic hinge (15). FIG. 4C shows a cross-sectional view of a bent sandwich panel with an elastic hinge (15), with the grooves (14A and 14B) in which the rigid outer layers (12A, 12B) have been removed.

FIG. 5A-5B explains a few definitions relating to this invention. FIG. 5A shows the front (16A) and the back (16B) of a sandwich panel, with a series of parallel T-shaped slits (7), wherein the long leg of each T is set at an angle of 90° with an edge of the cover, and extends to this edge of the cover, and with an indication of the edge (8) in which the T-shaped slits (7) are located, and a virtual line (17) which runs along the underside of the arms of the T's, from one side of the panel to the other side of the panel. Note that the front (16A) and back (16B) are each other's mirror image. The area between the edge (8) and the line (17) defines the area in which, in the context of this invention, the pattern of exposed flexible core layer will be located. The pattern of the exposed flexible core layer consists of one or more flexible surfaces, or consists of a series of elastic hinges. In any case, in the context of this invention, in this area, between 0.1% and 100% of the outer rigid layers (12A, 12B) of the sandwich panel is removed, and this on both sides, in such a way that the front (16A) and the back (16B) of the panel are each other's mirror image. FIG. 5B shows a detailed close-up, with indication of the long leg (10) of the T (7), and of the arms (11A, 11B) of the T (7). Also, the line (17) which runs underneath the arms (11A, 11B) of the T's (7), is also indicated, as is the edge (8) where the T-shaped slits (7) are located.

With regard to the drawings and FIGS. 6-10, herein, examples of embodiments of a rigid one-piece cover for disc-bound fold-over binding systems are shown. In accordance with these embodiments of the present invention, this rigid and one-piece cover consists of a rigid and one-piece sandwich panel, which includes a series of T-shaped slits, and a pattern of exposed flexible core-layer of the sandwich panel, located in the area between the edge (8) and a line (17) which runs along the underside of the arms of the T's. Drawings 6 and 7 deal with embodiments in which there is a pattern of flexible surfaces. Drawings 8 and 9 cover embodiments with a pattern of elastic hinging grooves. Drawing 10 shows an embodiment where the T-shaped slits are surrounded by the exposed flexible core layer.

FIG. 6A-6C shows a first embodiment in the context of this invention with a pattern of exposed flexible core layer situated in the area between the edge (8) and the line (17) where 100% of the outer layers (12A and 12B) are removed. The whole area located between the edge (8) and a line (17) which runs along the underside of the arms of the T's is thus a flexible surface. FIG. 6A shows the front (16A), —and the back (16B) of a first embodiment of a cover consisting of a sandwich panel, in which in 100% of the area between the edge (8) and the line (17), the outer layers (12A, 12B) have been completely removed, and one can only see the exposed core layer (13). Note that 16A and 16B are each other's mirror image. FIG. 6B shows a close-up of a portion of this embodiment. Since the flaps (9A, 9B) are located in this area and now consist only of the flexible core layer, they are elastic enough to be connected to the discs. FIG. 6C shows a side view of the lower edge of the cover.

FIG. 7A-7B shows a second embodiment in the context of this invention where a pattern of exposed flexible core layer is situated in the area located between the edge (8) and a line (17) which runs along the underside of the arms of the T's. In this embodiment only in the areas directly situated underneath the arms of the T's (7) 100% of the outer layers (12A, 12B) from the sandwich panel are removed. In the area located between the edge (8) and the line (17), one thus finds a series of flexible surfaces. The number of flexible surfaces here is twice the number of T-shaped slits. FIG. 7A shows the front (16A), —and the back (16B) of a second embodiment of a cover consisting of a sandwich panel, where the outer layers (12A, 12B) are completely removed on all the surfaces which are underneath the arms of the T's (7). So, between the edge (8) and the underside of all arms of the all T's (7) only the exposed core layer (13) remains. Note that 16A and 16B are each other's mirror image. FIG. 7B shows a close-up of a portion of this embodiment. Here, too, the flaps (9A, 9B) are elastic enough to be connected to the discs.

In FIGS. 8A-8B and FIGS. 9A-9B an embodiment of the described invention in question is shown, where, in the area between the edge (8) and a line (17) which runs along the underside of the arms of the T's, elastically hinging grooves are created instead of flexible surfaces. These grooves run from the tip of each arm of each T to the edge (8), where the slits are located, according to an angle α in relation to this edge (8). FIG. 8A shows the front (16A), —and the back (16B) of an embodiment of a cover consisting of a sandwich panel, with a groove (14A, 14B) on both sides of the panel, per each arm of each of the T's (7). These grooves run from the tip of each arm of each T to the edge (8) according to an angle α of approximately 45°. This angle α may be between 30° and 91°. FIG. 8B shows a close-up of a portion of this embodiment. The elastically hinging flaps (18A, 18B), which are formed by the grooves but still contain the outer layers, (12A and 12B) can elastically hinge open and close in order to be connected to the discs. Note that the pattern of grooves on both sides (16A, 16B) of the panel is the same. In other words, the front and back of the panel are each other's mirror image.

FIG. 9A shows the front (16A), —and the back (16B) of an embodiment of a cover consisting of a sandwich panel, with a groove (14A, 14B) on both sides of the panel, per each arm of each of the T's (7). These grooves run from the tip of each arm of each T to the edge (8) according to an angle α of 90° and are therefore perpendicular to this edge. FIG. 9B shows a close-up of a portion of this embodiment. The elastically hinging flaps (18A, 18B), which are formed by the grooves but still contain the outer layers, (12A and 12B) can elastically hinge open and close in order to be connected to the discs. Note that the pattern of grooves on both sides (16A, 16B) of the panel is the same. In other words, the front and back of the panel are each other's mirror image.

FIG. 10A-10B shows an embodiment with expanded area of exposed flexible core layer, so that the T's are completely surrounded by the flexible core layer.

In FIG. 10A an embodiment is shown where the area of the exposed flexible cover extends from the edge of the cover to a virtual line (17) which runs parallel to the arms of the T's more distal from edge (8), so as to completely encompass the T's (7). Thus, in these embodiments, the T's are completely surrounded by the exposed flexible core layer (13) of the sandwich panel. This has the advantage that, once the rigid outer layers (12A, 12B) of the sandwich panel are removed, the T's (7) can easily be punched out of the flexible core layer. A close-up of this embodiment is shown in FIG. 10B.

1. A cover (2) for disc-bound, fold-over binding systems, comprising a series of parallel T-shaped slits (7), wherein the long leg (10) of each T (7) is disposed at an angle of 90° with a straight edge (8) of the cover, and extends to this edge (8) of the cover, characterized by the fact that the cover consist of a one-piece sandwich panel containing two rigid outer layers (12A, 12B), which are permanently attached to a flexible core layer (13), wherein the sandwich panel is provided with an area which runs parallel to the edge (8) of the cover wherein between 0.1% and 100% of the outer layers (12A and 12B) of the sandwich panel is removed.

2. The cover according to claim 1 wherein the area is located between the edge (8) and a line (17) which runs along the underside of the arms of the T's.

3. The cover according to claim 1, wherein the flexible core layer is exposed over the entire surface of said area.

4. The cover according to claim 1 wherein the flexible core layer only is exposed in the areas situated directly under the arms of the T's (7).

5. The cover according to claim 1, wherein the flexible core layer is exposed by grooves that run from the tip of each arm of each T (7) to the edge (8), according to an angle α in relation to this edge (8), wherein this angle α is between 30° and 91°.

6. The cover according to claim 1, where the flexible core layer is exposed in an area which runs parallel to the edge (8) of the cover so that the T's are completely surrounded by the flexible core layer.

7. The cover according to claim 6, wherein this area extends between 0.8 and 1.5 cm from the edge (8) of the cover.

8. The cover according to claim 1, which further contains one or several holes or slits to allow the passing through of an elastic band or another closing element.

9. The cover according to claim 1, in which the sandwich panels consist of outer layers of aluminum and a polypropylene core layer.

10. A set of two or more covers according to claim 1.

11. A set of two or more covers according to claim 10, wherein on one or more of said covers the outer layer is also removed in accordance with a specific pattern on one side of the cover.

12. A binding system that contains a set of covers according to claim 10, and one or more matching discs.

13. A binding system according to claim 12, which further includes one or more elements such as paper or soft plastic, with the same T-shaped slits.

14. The binding system according to claim 12, wherein the set of discs is made of aluminum.

15. The binding system according to claim 12, wherein the set of discs is made of PMMA.
